(19) United States
(12) Patent Application Publication
(10) Pub. No.: US 2024/0218858 A1
(43) Pub. Date: Jul. 4, 2024

(54) ELECTRIC POWER GENERATING APPARATUS

(71) Applicant: Eugene A. Giannotta, Naples, FL (US)

(72) Inventor: Eugene A. Giannotta, Naples, FL (US)

(21) Appl. No.: 18/093,280

(22) Filed: Jan. 4, 2023

(51) Int. Cl. F03G 7/08; H02K 7/18

(52) U.S. Cl. CPC F03G 7/087; H02K 7/1853; E01C 11/26

(57) ABSTRACT

An electrical generating apparatus comprises a raised platform positioned on a roadway which includes a housing having a plurality of removable and replaceable modules. Each module of the plurality of modules includes at least one protrusion, at least one rotatable shaft, and at least one generator, which are all operably connected. The at least one protrusion extends above an upper surface of the module in an initial position, and the protrusion is flat or planar relative to the upper surface in a secondary position. When the at least one protrusion of one module of the plurality of modules is moved to the secondary position by the tires of a vehicle passing over the protrusion, the movement of the at least one protrusion creates a rotation force which causes rotation of the at least one rotatable shaft, which causes rotation of the at least one generator thereby generating electricity.

### TECHNICAL FIELD OF THE INVENTION

The present invention discloses an electrical power generating apparatus. More specifically, the present invention relates to an electrical power generating apparatus for generating electrical power by utilizing and converting the moving weight of objects, such as the tires of vehicles as they contact and move over a platform that includes a plurality of removable modules containing electrical power generating apparatus.

### BACKGROUND OF THE INVENTION

The United States and other countries around the world are working toward finding sources of clean energy, such as electricity produced from sources other than fossil fuels. There is currently a worldwide transition, at least partially, to electric vehicles powered by batteries. However, this transition will also require the production of more electricity to power these vehicles.

It would be desirable to generate electricity from roadways. Some electrical power generating apparatus exist to generate and harvest energy from moving vehicles and convert this energy into electricity. However, problems exist in these apparatuses. These apparatuses significantly slow down the speed of vehicles and cause them to use more energy to advance. In addition, these electrical power generating apparatuses do not harvest sufficient energy to justify the large cost of development, installation, operation, and maintenance of the apparatus. Further these power generating apparatuses have other issues. Some fail to offer an efficient solution for transferring the electricity produced by the apparatuses. Other power generating apparatus fail to sufficiently address how to keep water, dirt, etc. from damaging power generating equipment, electrical equipment, or electronics, or how to maintain items of the power generating apparatus that will incur significant wear and tear as a result of normal operation of the power generating items in the power generating apparatus, or how to prevent snow and ice from building up on the power generating apparatus and thus limiting its operation or damaging its equipment. Further, other electrical power generating apparatus fail to address roadway contours, such as the crown of roads, curves, and the like. Some power generating apparatus do not have a reliable manner to install or affix miles of the apparatus to a roadway, so are of limited use for significant electric power production. Therefore, there is a need to provide an electrical power generating apparatus which overcomes these limitations.

### SUMMARY OF THE INVENTION

In one embodiment of the present invention, an electrical generating apparatus comprises a raised platform positioned on a surface that at least one vehicle traverses. The platform includes a housing configured to conform to a roadway. The housing is configured to receive a plurality of modules. Each module of the plurality of modules includes 1) at least one protrusion, 2) at least one rotatable shaft, and 3) at least one generator. The at least one protrusion, the at least one rotatable shaft, and the at least one generator are operably connected within each module. At least a portion of the at least one protrusion of each module of the plurality of modules is configured to extend above an upper surface of each module in an initial position, and the at least a portion of the at least one protrusion is also configured to be substantially planar relative to the upper surface of each module of the plurality of modules when in a secondary position. At least one reset member is positioned within each module and it is configured to permit movement of the at least one protrusion between the initial position and the secondary position when a push force is applied to create the movement. When the at least one protrusion of each module of the plurality of modules is pushed to a secondary position by a tire of the vehicle moving over the at least one protrusion, the movement of the at least one protrusion creates a rotation force which causes rotation of the at least one rotatable shaft, which in turn causes rotation of the at least one generator such that the at least one protrusion translates a push force to a rotation force from the at least one rotatable shaft to the at least one generator to create electrical generation therefrom. The apparatus also includes a first subset of the plurality of modules axially aligned and positioned in a first portion of the housing of the raised platform, and a second subset of the plurality of modules axially aligned and positioned in a second portion of the housing of the raised platform. The first subset of the plurality of modules and the second subset of the plurality of modules are spaced apart from each other such that the platform includes an inactive area without electrical generation therefrom. The inactive area is formed without any modules positioned therein. The inactive area is positioned between the first subset and the second subset, such that the first subset, the inactive area, and the second subset are positioned in an axial alignment relative to each other and relative to an axial alignment of the platform which is positioned on the surface comprising a lane of the roadway. The at least one vehicle moves over and contacts the at least one protrusion of one module of the plurality of modules of the first subset or the second subset, thereby causing generation of electricity.

In one aspect of the one embodiment, each module of the plurality of modules is configured to be easily and quickly disconnected from the plurality of modules and removed from the housing, to permit each module to be rapidly replaced by another module of the plurality of modules.

In another aspect of the one embodiment, the apparatus includes a heating and cooling system, which permits a heated fluid or a coolant fluid to be circulated via fluid lines in each module, to provide heating or cooling to each module of the plurality of modules. The heating and cooling system circulates a heated fluid to raise a temperature of each module above freezing, so when a frozen precipitation is present, the plurality of modules on the roadway will remain unfrozen which reduces or eliminates slipping of vehicles traversing over such modules in platform. The heating and cooling system comprises a geothermal heating and cooling system. A controller is used to control the heating and cooling system.

In still another aspect of the one embodiment, each module of the plurality of modules includes a primary housing and a secondary housing. The primary housing includes a frame including a plurality of walls, wherein more than one wall of the plurality of walls includes one or more openings therein. One or more plates are positioned on an upper edge of the plurality of walls. The one or more plates provide support for the at least one protrusion.

And in still yet a further aspect of the one embodiment, the apparatus includes a gearbox, and the rotatable shaft is connected to the gearbox. The gearbox and the at least one generator are positioned in the secondary housing. A clutch/bearing is positioned between the gearbox and the at least one generator.

Moreover, in another aspect of the one embodiment, each module of the second subset of the plurality of modules includes one or more modules configured in a mirror image relative to the first subset of the plurality of modules.

And in a further aspect of the one embodiment, each module of the second subset of the plurality of modules includes the at least one protrusion operably connected to the rotatable shaft, and the rotatable shaft is operably connected to a driveshaft that extends transversely between each module of the plurality of modules of the second subset to each module of the plurality of modules of the first subset, respectively. The driveshaft operably connects to each module of the plurality of modules of the first subset via an interface/adapter operatively connected to at least one of a) a gearbox and b) the at least one generator within each module of the of the plurality of modules of the first subset. Each driveshaft is positioned in the inactive area of the platform positioned between the first subset and the second subset.

And in yet a further aspect of the one embodiment, the apparatus includes at least one power storage unit that receives electrical generation from: a) the at least one generator of each module of the plurality of modules of the first subset and b) the at least one generator of each module of the plurality of modules of the second subset.

In still yet another aspect of the one embodiment, the housing of the apparatus includes sections, and the sections further include compartments for holding each module of the plurality of modules. The housing further comprises spacers formed to be positioned between at least one of a compartment and a section. The spacers permit the housing to follow the turns and contours of the roadway.

Moreover, in a further aspect of the one embodiment, the housing is also configured to be affixed to the roadway so that the ribs of the housing embed into an affixing material.

In another embodiment of the present invention, an electrical generating apparatus comprises a raised platform positioned on a surface that at least one vehicle traverses. The platform includes a housing configured to conform to a roadway. The housing is configured to receive a plurality of modules. Each module of the plurality of modules includes 1) at least one protrusion, 2) at least one rotatable shaft, and 3) at least one generator. The at least one protrusion, the at least one rotatable shaft, and the at least one generator are operably connected within each module. At least a portion of the at least one protrusion of each module of the plurality of modules is configured to extend above an upper surface of each module in an initial position, and the at least a portion of the at least one protrusion is also configured to be substantially planar relative to the upper surface of each module of the plurality of modules when in a secondary position. At least one reset member is positioned within each module and it is configured to permit movement of the at least one protrusion between the initial position and the secondary position when a push force is applied to create the movement. When the at least one protrusion of each module of the plurality of modules is pushed to a secondary position by a tire of the vehicle moving over the at least one protrusion, the movement of the at least one protrusion creates a rotation force which causes rotation of the at least one rotatable shaft, which in turn causes rotation of the at least one generator such that the at least one protrusion translates a push force to a rotation force from the at least one rotatable shaft to the at least one generator to create electrical generation therefrom. The apparatus also includes a first subset of the plurality of modules axially aligned and positioned in a first portion of the housing of the raised platform, and a second subset of the plurality of modules axially aligned and positioned in a second portion of the housing of the raised platform. The at least one vehicle moves over and contacts the at least one protrusion of one module of the plurality of modules of the first subset of the second subset, thereby causing generation of electricity.

In one aspect of the other embodiment, each module of the plurality of modules is configured to be easily and quickly disconnected from the plurality of modules and removed from the housing, to permit each module to be rapidly replaced by another module of the plurality of modules.

In another aspect of the other embodiment, the apparatus includes a heating and cooling system, which permits a heated fluid or a coolant fluid to be circulated via fluid lines in each module, to provide heating or cooling to each module of the plurality of modules. The heating and cooling system circulates a heated fluid to raise a temperature of each module above freezing, so when a frozen precipitation is present, the plurality of modules on the roadway will remain unfrozen, which reduces or eliminates slipping of vehicles traversing over such modules in platform.

### BRIEF DESCRIPTION OF DRAWINGS

The disclosure will be better understood, and features set forth above will become apparent when consideration is given to the following detailed description thereof. Such description refers to the annexed drawings wherein:

FIG. 1 is a perspective view of a module of the present invention;

FIG. 2 is a partial perspective view of the module of FIG. 1, showing the upper portions of the module, but not showing a lower frame of the module;

FIG. 3 is a top plan view of the module of FIG. 2;

FIG. 4 is a back perspective view of the module, showing the upper portion of the module separated from the frame of the module;

FIG. 5 is an upper perspective view of the module and frame of FIG. 4;

FIG. 6 is an upper right perspective view of the module and frame of FIG. 5;

FIG. 7 is an exploded perspective view of the module and frame of FIG. 6;

FIG. 8 is a right-side perspective view of the upper portion of the module and the spaced-apart frame of the module;

FIG. 9 is an exploded lower perspective view of a portion of the push force to rotation force assembly of the present invention;

FIG. 10A is a perspective view of a portion of the push force to rotation force assembly of FIG. 9;

FIG. 10B is a perspective view of the portion of the push force to rotation force assembly of FIG. 10A, but showing the portion of push force to rotation force assembly in an alternate position;

FIG. 11A is a top plan view of a lower surface of a portion of the module of FIG. 1;

FIG. 11B is a top plan view of the lower surface of the pair of protrusions of the module of FIG. 1;

FIG. 11C is a top plan view of the lower surface of the frame of the module of FIG. 1;

FIG. 12 is a left lower perspective view of a lower portion of the module and the frame of the module of FIG. 1;

FIG. 13 is a schematic block diagram of the electrical systems of the module of FIG. 1;

FIG. 14 is a schematic block diagram of a heating and cooling system for the module of FIG. 1;

FIG. 15 is a perspective view of the module of FIG. 1 connected to an alternative module;

FIG. 16 is a perspective view of a lower surface of a pair of subset housings configured to hold a plurality of modules carried in a first subset and a second subset in one lane of a roadway;

FIG. 17 is a perspective view of a pair of subset housings, showing one portion of the subset housings filled with modules, and another portion of the pair of subset housings having separate compartments, each compartment configured to hold a module;

FIG. 18 is a perspective view of a pair of subset housings filled with modules, showing the use of spacers to permit each of the pair of subset housings to conform to curves in the underlying roadway;

FIG. 19 is a side elevational view of the pair of subset housings holding a plurality of modules, and a leveler used to maintain the pair of subset housings at a level height;

FIG. 20 is a perspective view of a portion of a roadway carrying a pair of subset housings filled with a plurality of modules, and an entry ramp extending to the elevated platforms carrying the pair of subset housings;

FIG. 21 is a perspective view of a portion of a roadway having two lanes, each lane having a raised platform formed from a pair of subset housings having a plurality of modules held therein, each lane having a vehicle moving thereover;

FIG. 22 is a top plan view of a four-lane roadway, a vehicle traversing over each lane of the four lanes and over the plurality of modules carried by the pair of subset housings positioned in each of the four lanes;

FIG. 23 is a side cross sectional view of two axially aligned modules, showing a tire passing over one of the modules to illustrate the initial and secondary positions;

FIG. 24 is a perspective exploded view of a radial generator; and

FIG. 25 is a perspective exploded view of an axial flux generator.

### DETAILED DESCRIPTION OF THE INVENTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. The variations of “comprising”, “including” and “having”, such as, but not by way of limitation, “comprise”, “include”, “have” or “has”, are also included in this definition, as are the words “is” and “are”. Any examples of operating parameters and/or environmental conditions are not exclusive of other parameters/conditions of the disclosed embodiments.

The present invention relates to an electrical power generating apparatus for generating electrical power by utilizing and converting the moving weight of objects, such as a vehicle moving over a platform which carries an electrical power generating apparatus. The electrical power generating apparatus desirably is activated by the movement and pressure of the vehicle's tires as the vehicle moves over the platform. Ideally, the platform is positioned on top of road surfaces, such as, for example, highways, bridges, streets, and the like. The platform may cover one lane, or a plurality of lanes on each side of a roadway. It may extend for a short distance, such as a block or less, but more desirably, the platform extends for a mile or miles. The platform is formed from a housing which includes a plurality of modules which are activated to produce electricity when the tires of vehicles contact one or more protrusions extending from each of the plurality of modules. The modules are each self-contained and provide a manner of quickly repairing and/or replacing malfunctioning modules of the electrical power generating apparatus, without the need for stopping the use of the electrical power generating apparatus for long periods of time. This invention focuses on providing a housing for each self-contained module, and such a housing forms a platform over a roadway, thereby providing a feasible and economical model which permits limited downtime, ease of maintenance and repair, and reliable continuous generation of electricity, so long as vehicles move over the platform. And by way of non-limiting example, the electricity generated from such a platform may be sent to a power grid to power homes and businesses; it may power electric motors connected to the platform; it may be sent to energy storage devices, it may power electric vehicle's passing over the platform or vehicles connected to the platform.

On a roadway, a typical non-commercial vehicle may have its tires inflated in a range of approximately thirty to forty (30-40) pounds per square inch of tire pressure. Thus, the vehicle's weight is actually distributed throughout each square inch of each tire at the point that the tire contacts the road, or in the case of the present invention, activates a plurality of protrusions of modules by driving over the platform. The present invention endeavors to harness the weight/force of the vehicles depressing the protrusions of the modules on the platforms through vehicle tires, and endeavors to limit how much weight/force is required to depress the protrusions to a level at or below the actual weight of the vehicle that presses against the plurality of protrusions of modules on the platform via the vehicle's tires. Additionally, a typical roadway surface that vehicle tires contact, which in the examples shown and/or described herein is the roadway surface onto which the platforms are installed, is composed of asphalt or concrete and such roadway surfaces are not fully flat. That is, such roadway surfaces are usually worn and contain elevations, depressions, defects, cracks and are generally damaged. In contrast, the upper surfaces of the platforms of the present invention installed over these roadway surfaces is rigid and flat. The protrusions of the plurality of modules in the platforms are elevated so that their cumulative incline over a given area substantially requires vehicles to expend the same/equivalent energy to advance over the protrusions of the plurality of modules carried by each platform, as compared to the energy that each vehicle would have otherwise expended to advance over the asphalt/concrete roadway before the platforms were installed. Therefore, as a result of the installation of the platforms, there is no net incremental energy expended/used by vehicles as they drive over the protrusions of the platforms. In addition, when one or more platforms are installed in high traffic areas, each module in the platform may desirably include components to keep the plurality of generators held within the modules to continue producing electricity, even when traffic may stop briefly on the platform, if the platform is extended to include areas where cars remain in motion while in other areas traffic is briefly stopped. Further, the platform may be designed so that the plurality of modules on the platform are activated only when a force equal to or less than a specific pre-determined psi (pound per square inch) presses against one or more protrusions of the module to activate the module.

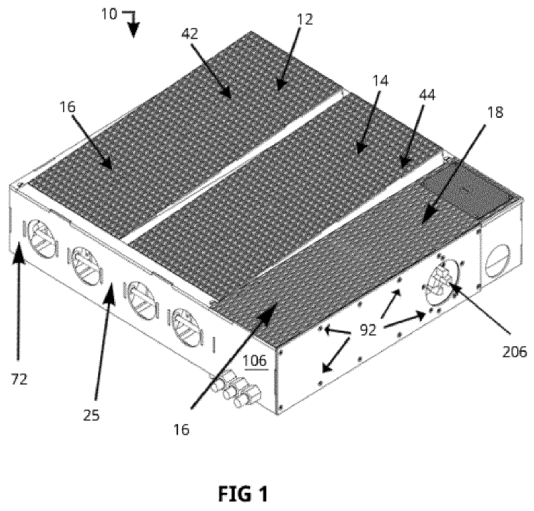

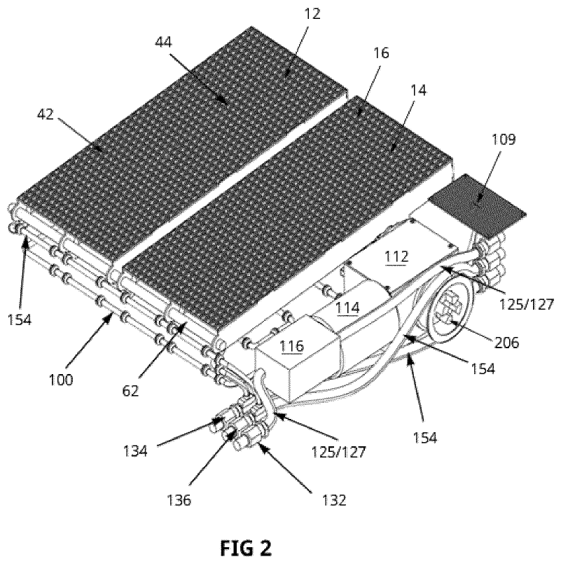

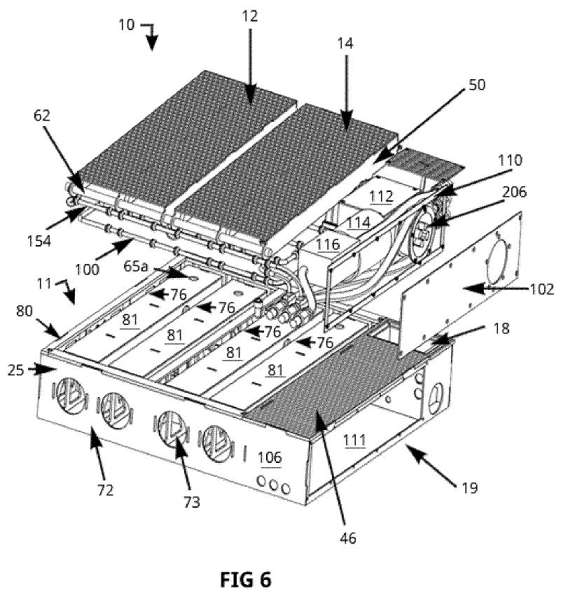

Turning to FIGS. 1-8, a module 10 desirably includes, in a primary housing 11 therein, at least one, and preferably more than one, protrusion, such as, but not by way of limitation, a pair of protrusions 12, 14, which extend upward from a top surface 16 of the module 10. A secondary housing 18 having an internal compartment 19 may be provided with and included in the module 10. In the present module 10, but not by way of limitation, the secondary housing 18 may desirably be positioned near the pair of protrusions 12, 14. Power may be generated starting with movement of the protrusions 12, 14 via a push force to rotation force assembly connected to a rotatable shaft 20 (FIGS. 2-10) which is operably connected to a gearbox 22 having at least one gear 23 or equivalent, that operates to rotate at least one generator 24 to produce electricity. A frame 25 is positioned about the module 10 and is provided as a part of the module 10 to provide support for the components and assemblies therein.

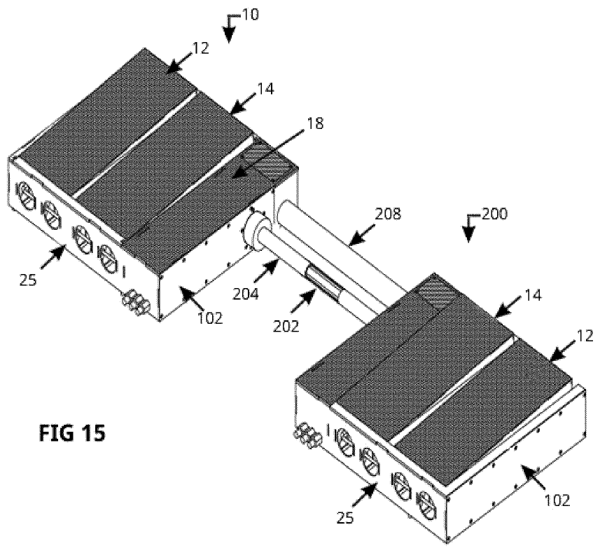

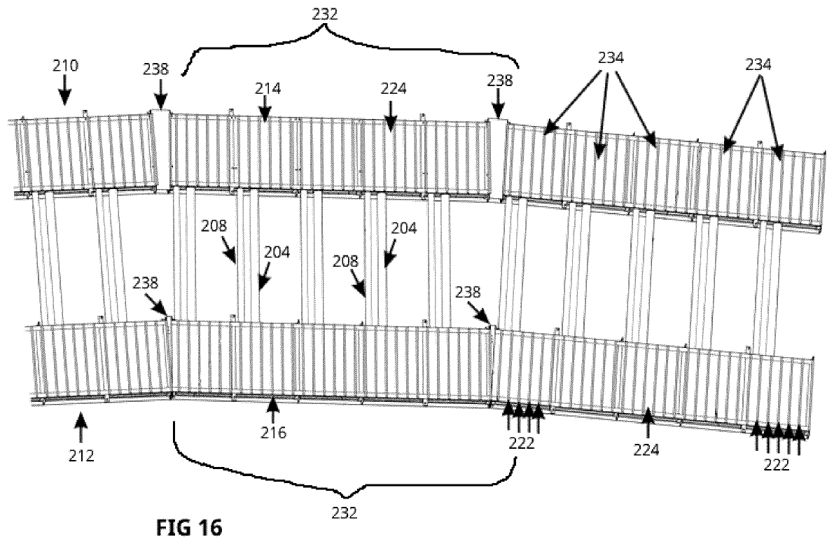

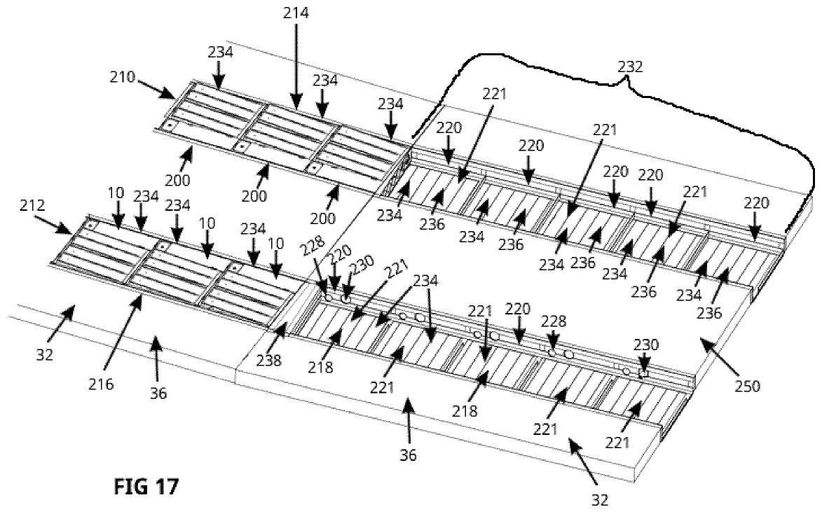

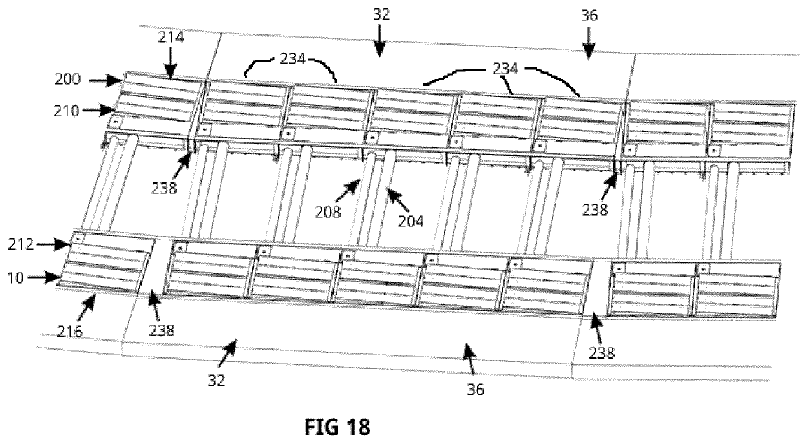

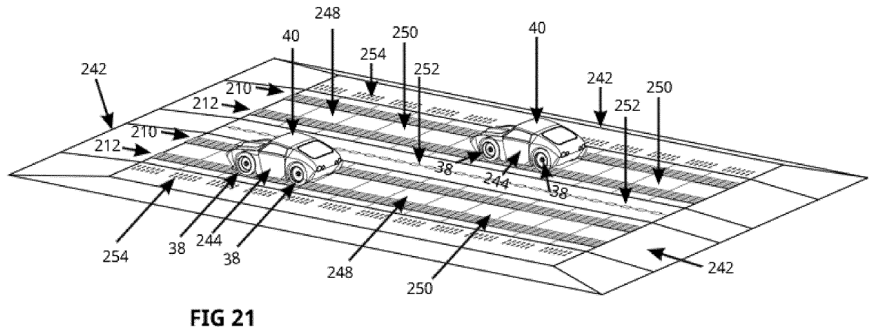

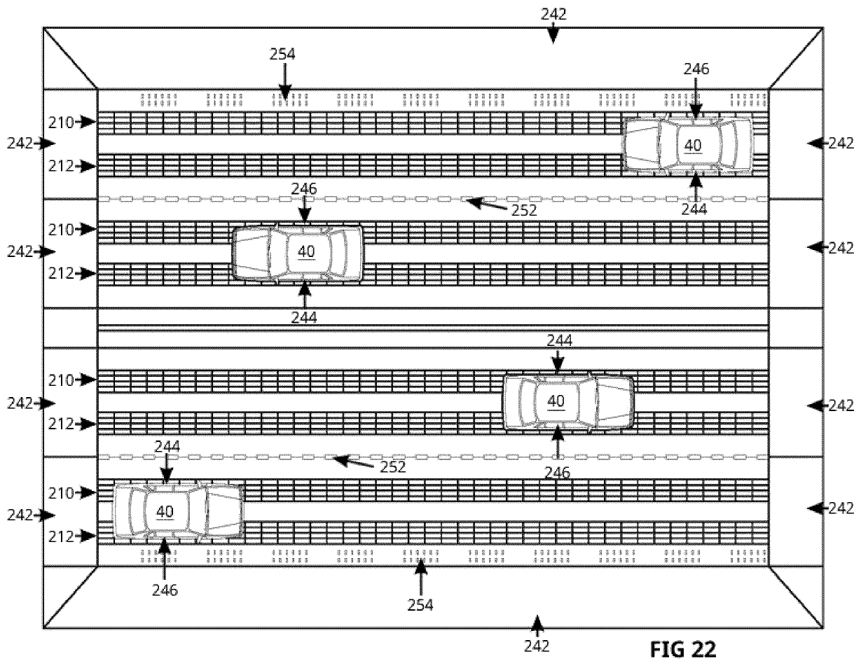

The module 10 may desirably be provided as a plurality of modules 10 and/or 200 (FIG. 15) that are positioned together in one or more subset housings 214, 216, which together form a raised platform 30 (FIGS. 17-22). The raised platform 30 may desirably be positioned over at least a portion of one lane 32 of a roadway 36, and more desirably, the raised platform 30 may be positioned over more than one lane 32 of a roadway 36 as illustrated in FIGS. 21 and 22 to generate electricity from the contact of tires 38 of vehicles 40 moving over the raised platform 30, and in particular, over the protrusions 12, 14 of each of the plurality of modules 10 and/or 200.

Referring to the module 10, as illustrated in FIGS. 1-7, an upper surface 42 of each protrusion 12, 14 desirably includes a frictional surface 44 positioned over the upper surface 42, which forms at least a portion of the top surface 16 of each module 10. The frictional surface 44 also desirably extends over an upper wall/surface 46 of the secondary housing 18. The frictional surface 44, that may include one or more materials which form the frictional surface 44, and which is used to reduce and/or prevent slippage when the tires 38 of a vehicle 40 contact and move or roll over the frictional surface 44. The frictional surface 44 may include at least one of ferrous material, metal, stone, and any material(s) known in the art and commercially available which operates as shown and/or described herein. Further, the top surface 16 of each module 10 may include a color to reflect sunshine away from each module 10 or may include a color to absorb the sun's rays to each module 10.

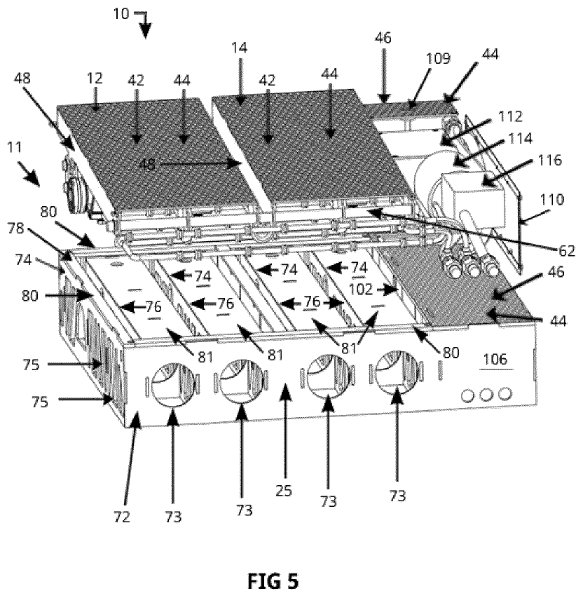

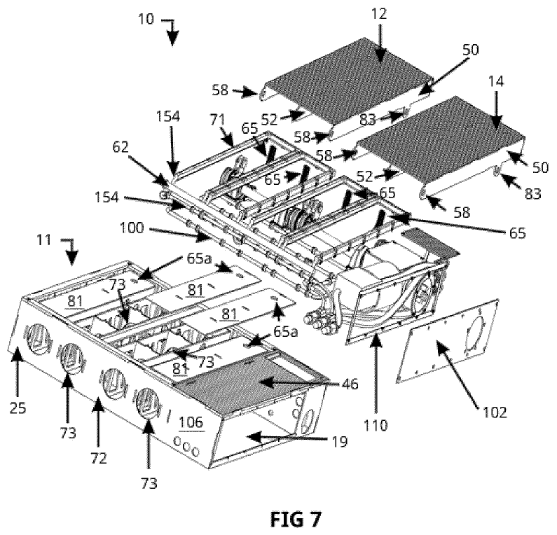

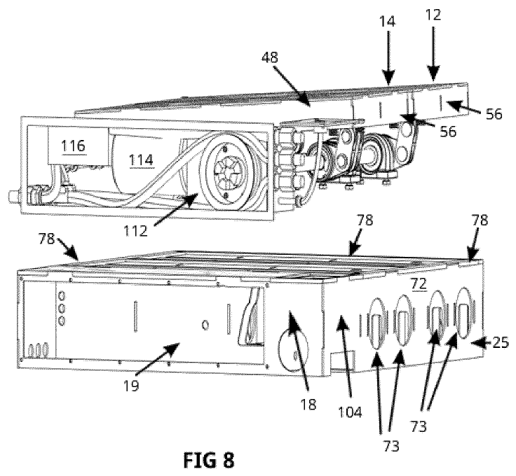

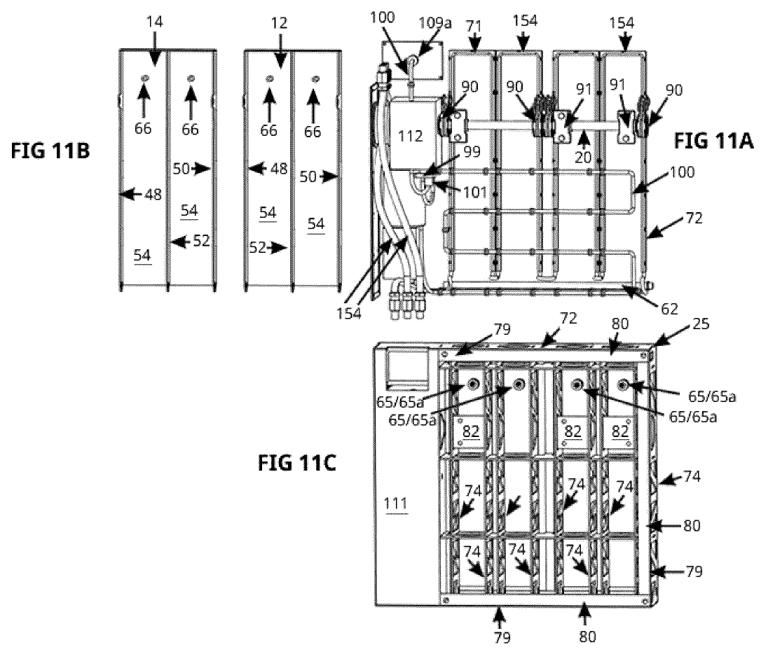

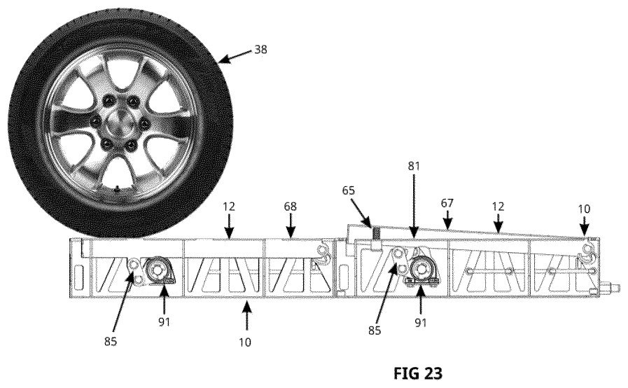

The pair of protrusions 12, 14 as illustrated in FIGS. 5-8, desirably each includes two-spaced-apart sidewalls 48, 50 positioned on each lateral edge of each of the pair of protrusions 12, 14 and the sidewalls 48, 50 extend downward from each edge. An additional flange or center wall 52 may be positioned on a lower surface 54 of each protrusion 12, 14, and may be positioned parallel to the sidewalls 48, 50. In addition, as shown in FIGS. 7-8, each protrusion 12, 14 includes a front edge including a front wall 56 connected to the front edge and which extends downwardly therefrom. The sidewalls 48, 50 and the front wall 56 are formed to support each protrusion 12, 14 and also to reduce and/or prevent water, dirt, ice, road debris, and the like, from entering an opening from which each protrusion 12, 14 extends. The sidewalls 48, 50, the center wall 52, and the front wall 56, cooperate to provide additional strength and rigidity to each protrusion 12, 14. The sidewalls 48, 50, the center wall 52, and the front wall 56 may also assist in the harnessing and transferring energy when the protrusions 12, 14 are pushed downward. Each protrusion 12, 14, also includes a rear edge 60. Each of the pair of protrusions 12, 14 may desirably be pivotally connected to a rod 62 via openings 58 formed in a rear portion of each of the two spaced-apart sidewalls 48, 50, and an opening 58 formed in a rear portion of each center wall 52. A plurality of reset members 65, as shown in FIG. 23, may be positioned under a front portion of each protrusion 12, 14, to urge each protrusion 12, 14 upward. Such reset members 65 may include a spring, pulley system, or other apparatus known in the art and commercially available that functions as shown and/or described. Alternatively, or in addition thereto, the rod 62 may desirably include at least one reset assembly per protrusion 12, 14 as well. Such reset assemblies may include, by way of non-limiting example, a latch spring hinge, a spring-loaded hinge, and the like. Desirably, such reset assemblies are also configured to contact and push against the lower surface 54 of each protrusion 12, 14 to urge each protrusion 12, 14 upward. One or more guideposts 66 may be used to guide the bottom surface 54 of each protrusion 12,14 as they contact each reset member 65. In the example illustrated in FIGS. 11B and 11C, two guideposts 66 are positioned on each protrusion 12, 14, and each guidepost 66 connects or comes into contact with a reset member 65. The reset members are positioned within a reset member holder 65A.

Each of the pair of protrusions 12, 14 may be moved downward, into a flat, secondary position 68 (FIG. 23) when the tires 38 of a vehicle 40 contact and move over each protrusion 12, 14, pushing each protrusion 12, 14 downward therefore moving each protrusion 12, 14 into a secondary position 68. Each reset member 65 permits the elevated end of each protrusion 12, 14 to be re-positioned into the upward initial position 67 (FIG. 23) after each protrusion 12, 14 is pushed downward, into the flat, secondary position 68, as shown in FIG. 23. The secondary position 68 of each protrusion 12, 14 places each protrusion 12, 14 in a position that is consistent with activating each push force to rotation force assembly positioned below the pair of protrusions 12, 14 and connected to the pair or protrusions 12, 14.

The pair of protrusions 12, 14, when depressed downward into their downward flat secondary position, may be supported by a plurality of covers 81 which are positioned on top of sidewalls 72 and internal frames 76. A space may be provided to permit the center wall 52 and side walls 48, 50 of each protrusion 12, 14 to move between sidewalls 72 and internal frames 76.

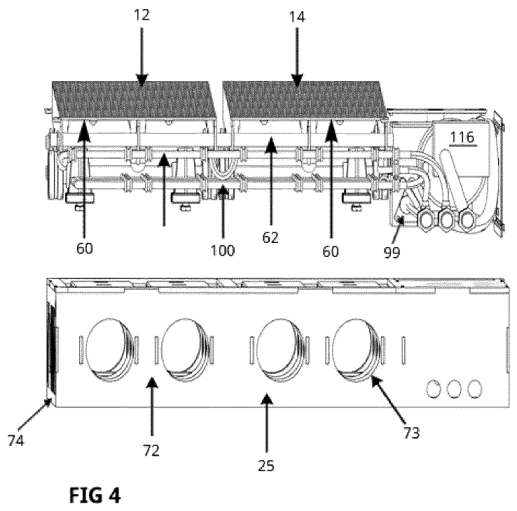

The upper portion of the module 10 is held within the frame 25, as illustrated in FIG. 1. As shown in FIGS. 4-8, 11C, and 12, the frame 25 provides strength and support for the module 10 and the protrusions 12, 14 positioned therein. The frame 25 may comprise one pair of spaced-apart sidewalls 72 which may include a plurality of circular openings 73 or other opening shapes, positioned in a portion thereof to reduce the amount of material needed without compromising the needed structural integrity. Additional sidewalls 74 may be positioned and connected between the spaced-apart sidewalls 72. Sidewall 74 may also include a plurality of openings 75 therein; the plurality of openings 75 may have inner perimeters which form a variety of shapes and sizes. A plurality of internal frames 76, in this example, but not by way of limitation, four rectangular internal frames 76, are formed within the frame 25. Each elongated wall of each internal frame 76 may be substantially identical to at least a portion of sidewall 74. Each end wall of each internal frame 76 may be substantially identical to at least a portion of sidewalls 72. Each internal frame 76 may include a plurality of transversely positioned walls 77 positioned therein which may be positioned in a spaced apart orientation relative to each other, which also may be substantially identical to at least a portion of sidewalls 72. Each of the plurality of internal frames 76 are spaced apart from each other, and desirably from each sidewall(s) 72, 74 of the fame 25. In this manner, the frame 25 provides space for other components which may be held within the frame 25, such as a fluid pipeline assembly which brings heating and cooling to at least a portion of each module 10, and the like, which will be discussed in detail below. An upper edge 78 and a lower edge 79 of the frame 25 each includes a lip 80 positioned about each upper and lower edge 78, 79. The frame 25 and the plurality of internal frames 76 desirably provides strength while also permitting dissipation of vapor, liquid, heat, and/or cold, as well as permitting other components to be positioned within at least a portion of the frame 25 of the module 10. The plurality of internal frames 76 positioned below each protrusion 12, 14 may also include a plurality of covers 81 positioned over each internal frame 76, to further assist in the support the pair of protrusions 12, 14 and the module 10. One or more plates 82 (FIG. 11C) may also be affixed to one or more of the frame walls 72, 74, 77 to provide a base onto which to affix one or more pillow block bearing 91 or bearing/clutch 90, 90a. A lower end of the frame 25 which may be defined by one lip 80 of the frame 25 may be open, or alternatively, the frame 25 may include a lower wall (not shown).

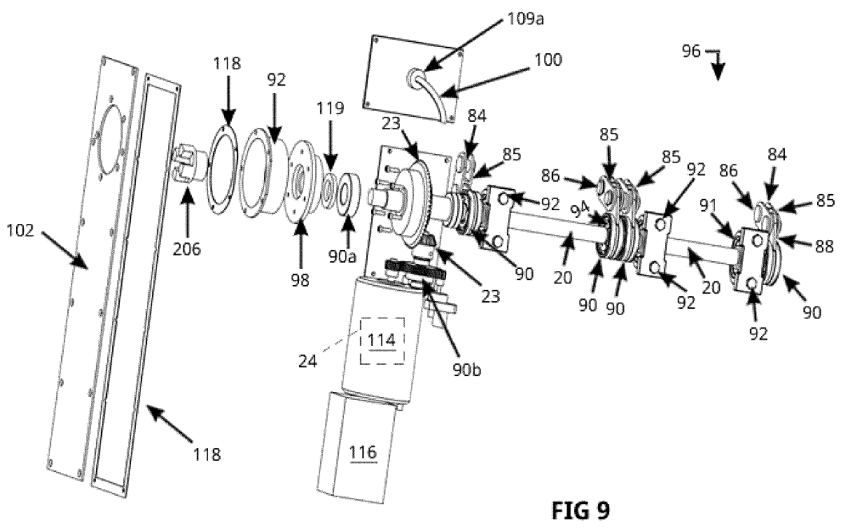

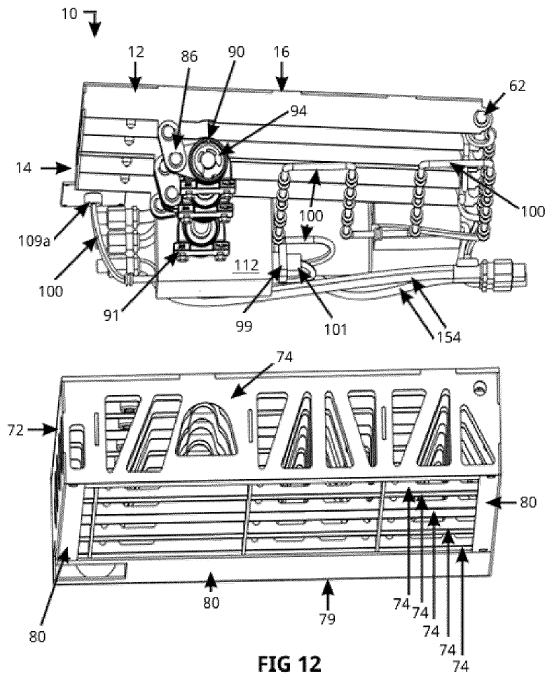

Returning to the pair of protrusions 12, 14, as shown in FIG. 7, each sidewall 48, 50 of each protrusion 12, 14 may include an aperture 83 in each sidewall 48, 50 positioned toward the front end of each protrusion 12, 14 (FIGS. 8 and 12). One end 84 of a linkage 85 may desirably be connected to each sidewall 48, 50 via a pin 86 or fastener, which is inserted through both a portion of the linkage 85 and through the aperture 83 in each sidewall 48, 50. An opposite end 88 of the linkage 85 may connect in the same manner to at least one bearing and/or at least one clutch, wherein the at least one bearing and/or the at least one clutch, respectively, is at least one of a one-way bearing or one-way clutch, referred to herein as a “bearing/clutch” 90, as shown in FIGS. 9, 10A, 10B, and 12. Each bearing/clutch 90 is at least operably connected to a rotatable shaft 20. Each bearing/clutch 90 may be, for example, but not by way of limitation, a one way bearing, a sprag clutch bearing, a freewheel bearing/clutch, a one-way clutch, a ratchet, ratcheting freewheels, and the like. Each bearing/clutch 90 may include at least one of a metal and a ceramic.

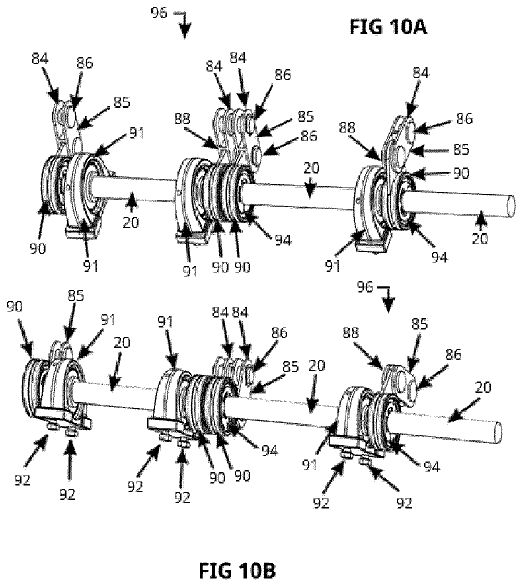

Each bearing/clutch 90 is desirably connected to the rotatable shaft 20 via a fastener 92, which may include, by way of non-limiting example, a key, a spline, a screw, bolt, pin, weld, a hex connector screw, and the like. A bearing lock ring 94 (FIGS. 9, 10A, and 10B) may also be used to prevent each one-way bearing/clutch 90 from slipping out of its location on the rotatable shaft 20. Each protrusion 12, 14, when activated and moved from its initial position 67 to its secondary position 68, moves the linkage 85 downward, which causes the bearing/clutch 90 to rotate and the rotation of the bearing/clutch 90 causes rotation of the rotatable shaft 20. It will be understood that the rotatable shaft 20 may have any functional outer perimeter configuration. The combination of the linkage 85 and the bearing/clutch 90, when activated by the downward movement of each protrusion 12, 14, provides the push force to rotation force assembly 96.

The push force to rotating force assembly 96 and the rotatable shaft 20 may desirably be positioned inside of each module 10. In the present example, but not by way of limitation, one or more push force to rotation force assemblies 96 may be movably connected to each protrusion 12, 14 of the pair of protrusion, and to the rotatable shaft 20. However, it will be understood that any number of push force to rotation force assemblies 96 may be connected to the rotatable shaft 20, so long as the module 10 operates as shown and/or described herein. For example, each push force to rotation force assembly 96 desirably includes one or more bearing/clutches 90 that urges the rotatable shaft 20 to continue to rotate in one desired direction even after the initial activation of the push force to rotation force assembly 96 via downward movement of one or both protrusions 12, 14 has ended. Alternatively, one or more bearing/clutches 90 may permit rotation of the rotatable shaft 20 in each direction (not shown). When the push force to rotation force assembly 96 is activated to rotate the rotatable shaft 20, the rotatable shaft 20 is operably connected to the gearbox 22 and gear(s) 23 or equivalent and to the generator 24, which are both held within the secondary housing 18 of at least one module 10.

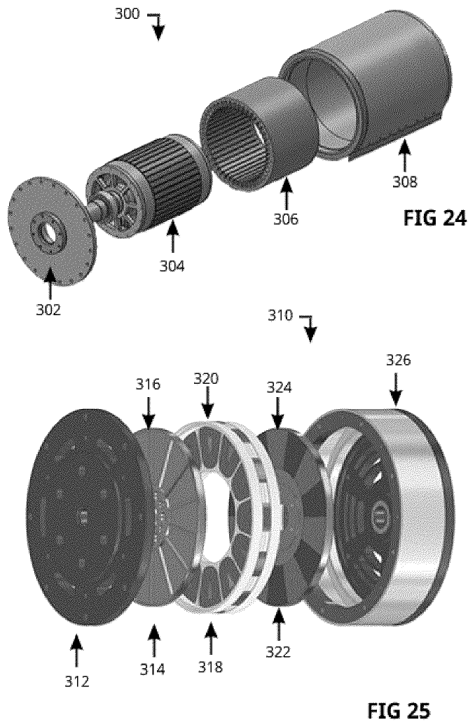

The components held in the internal compartment 19 of the secondary housing 18 may include for example, but not by way of limitation, a portion of the rotatable shaft 20, the gearbox 22 having one or more gears 23 (the gearbox 22 may include a gear train, in line gears, or planetary gear(s) (not shown) (herein referred to as “equivalent”)) (FIGS. 5-9). Any gearbox 22 or equivalent desirably may operate to increase the rotational output (rotations per minute or RPMs) of the rotatable shaft 20 operatively connected to at least one generator 24. Output torque from the gearbox 22 is passed on to the at least one generator 24, resulting in the production of electricity from the generator 24. Alternatively, the rotatable shaft 20 may directly rotate or power the generator 24 without the gearbox 22 (not shown). The at least one generator 24 may be one or more generators, such as, but not by way of limitation, an AC generator, a DC generator, a radial generator, an axial flux generator, a linear generator, an out-runner generator, an in-runner generator, and the like. Two generators which may be used are illustrated in FIGS. 24 and 25, and they are discussed herein below. The one or more generators 24 may also include one or more rotors, stators, bearings, magnets, insulated coils, and the like. When a rotatable shaft 20 enters the gearbox chamber 112 or a water/fluid tight compartment it also passes through a rotary shaft seal 119 in order to prevent environmental water/moisture from entering the sealed waterproof chamber. The waterproof seal also prevents fluid from exiting the water/fluid tight chamber. The rotary shaft seal 119 may be one of, but not limited to, a radial shaft seal, shaft sealing ring, oil seal rotary shaft seal, or any other seal commercially available that operates as shown and/or described herein.

One or more bearing(s) 90b (one way bearing/clutch) may be positioned between the mechanical power output end of the gearbox 22 and the generator 24. One or more bearings 90a (two way bearing) may be positioned on the rod between the gearbox 22 or equivalent and the interface 206. Each one-way bearing/clutch 90 or bearing 90b permits the generator 24 to continue to rotate even when the push force to rotation force assembly 96 is not currently activated, because without such activation, the gear(s) 23 of the gearbox 22 or equivalent and/or the rotatable shaft 20 would act like a brake or a drag on the generator 24 to slow or stop the rotation of the generator 24 prematurely. In one embodiment, the various bearing/clutches 90 connected to the rotatable shaft 20 may be eliminated and only the bearing clutch 90b or clutch positioned between the gearbox 22 and the generator 24 remains. A mount or holder 98 may be used in some instances to support at least a portion of the bearing 90a positioned within the secondary housing 18, and the mount or holder 98 may, in some instances, be connected to a wall of the secondary housing 18 of the module 10.

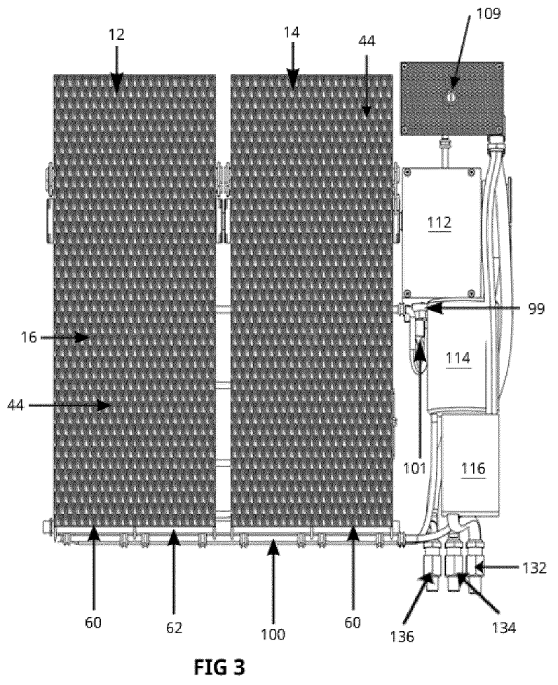

Each bearing/clutch 90, 90b may be sealed and include a lubrication grease, lubrication fluid, and the like. In a lubricating assembly, a pump 99 may pump lubrication fluid through lubrication tubing 100 through a chamber 112 holding the gearbox 22 and gear(s) 23 (or equivalent), and the lubrication tubing 100 may also extend to move the lubrication fluid into a chamber 114 holding one or more generators 24 to lubricate or cool the one or more generators 24 as well. In one non-limiting example the lubrication fluid pump 99 is located after the gearbox in order to speed up the operation of the pump 99. In addition, the lubrication fluid may be pumped to additional chambers and/or apparatus within the secondary housing 18. A filter 101 to filter the lubrication fluid may be connected to the lubrication tubing 100 as well; such filters are known and are commercially available. The lubricant tubing 100 may desirably extend out of the secondary housing 18 and into other areas of the module 10. For example, but not by way of limitation, the lubrication tubing 100 may be positioned below each of the protrusions 12, 14, to cool the lubricating fluid before returning the lubricating fluid to the gearbox chamber 112, as illustrated in FIGS. 7, 11A, and 12. The lubricating fluid may be held within the gearbox chamber 112 located in the secondary housing 18 within the lubrication tubing 100 or, alternatively, a container (not shown). In another alternative, the lubricating fluid may be provided from a source external to the secondary housing 18 and may be moved into the secondary housing 18 via the access port 109, as shown in FIGS. 3 and 5. Beneath the access port 109 may be a press button oiler or Schrader valve 109a that opens to allow fluid to pass through when force is applied and that closes automatically when the force is released and thus acts as a type of failsafe to ensure the port of entry of the lubrication fluid is closed when work is completed. Desirably, the lubricating fluid in the lubricating tubes 100 continues to move through the closed loop system illustrated herein to continue to cool at least the gearbox 22 or equivalent, the generator(s), and any other components held within the secondary housing 18 which require lubrication or cooling. Any pump that operates as shown and/or described herein and is commercially available may be used. However, it will be understood that as an alternative, the gear(s) 23 of the gearbox 22 and other components within the secondary housing 18 may be packed in lubricating grease. Another option to dissipate or remove or transfer heat from items contained inside water and airtight compartments such as the secondary housing 18, is to attach one or more heat sinks or fins (not shown) to at least an outside wall of the water and airtight compartment, so that heat is drawn out of the compartment and transferred to a cooler area or compartment. In one instance, the cooler area may be located in the primary housing 11 because as the protrusions move, they circulate air and draw away heat from the heat sink and thus the area, or secondary housing 18, containing the heat source.

The secondary housing 18, as illustrated in FIGS. 1 and 6-8, desirably includes a pair of spaced-apart lateral walls 102, a front end wall 104 and a rear end wall 106 (both 104 and 106 may be formed from a portion of one of the pair of sidewalls 72 of the frame 25), an upper wall 46, which desirably includes at least one access port 109, and a seal 110 may be positioned about at least the one outer sidewall 102 of the secondary housing 18. A lower wall 111 is also desirably included as a portion of the secondary housing 19. The access port/door 109 permits access to components, and the like, within or that pass through the secondary housing 18. It will be appreciated that all walls and surfaces may be sealed by various means, and the access port/door 109 also may be releasably sealed. All sidewalls 102, front end wall 104 and/or rear end wall 106 may include and/or be connected to a portion or a wall of the frame 25, as previously described. It will be appreciated that components entering, exiting, or held within the internal compartment 19 of the secondary housing 18 may desirably be held within separate chambers and the openings into the chambers and/or the secondary housing 18 may be sealed to prevent entry of external water, dirt, debris, and the like. Such sealed chambers may desirably include the gearbox chamber 112 for the gearbox 22 and the generator chamber 114 for the generator(s) 24. In addition, an electrical and electronics chamber 116 is connected to the generator chamber 114 and the generator(s) 24 therein may connect to one or more electrical components held therein. The gearbox chamber 112, the generator(s) chamber 114, and the electrical and electronics chamber 116 may desirably include one or more seals, gaskets, and the like, in order to prevent contamination by environmental elements, such as those described above, from entering any of the chambers for the gearbox, generator, or electrical chambers 112, 114, and/or 116, respectively.

Desirably, openings into the secondary housing 18, or the chambers 112, 114, 116 therein, are sealed by one or more seals or gaskets 118. For example, at least one gasket 118 is placed where at least two joining items come together. Another gasket 118 is located and positioned between one outer sidewall 102 (which allows entry into chamber 112, 114, and/or 116, containing the gearbox box 22 or equivalent, the generator(s) 24 and the electrical and electronics, respectively) and the frame 25 onto which the outer sidewall 102 is affixed. The outer panel 102 is affixed to the frame 25 of the module 10 via more than one fastener 92. It will by understood that one or more chambers, housings, and the like, of each module 10 may be sealed. Some examples of apparatus to provide seals include, but not by way of limitation, gaskets, seals, packings, wax, sealants, caulks, and the like. Any sealing apparatus known in the art and commercially available may be used, so long as it permits the component sealed to operate as shown and/or described herein.

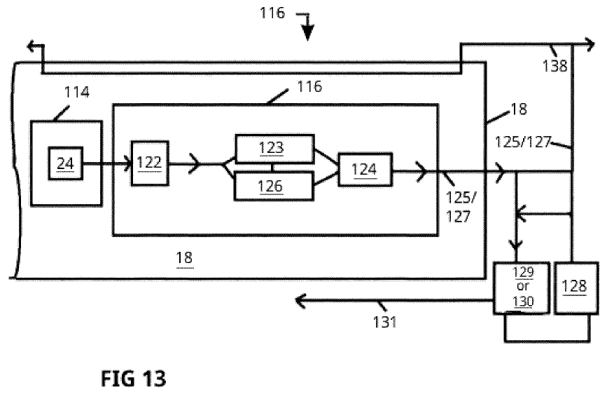

The electrical and electronics chamber 116 of the secondary housing 18, as shown in FIG. 13, desirably may include, for example, a rectifier/converter 122 which converts alternating current (AC) provided from the generator(s) 24. At least one generator 24 is operably connected to the rectifier/converter 122 which may convert, for example, but not by way of limitation, three (3) phase AC produced by the at least one generator(s) 24 to direct current (DC). The DC is then operably passed to a DC booster 123, which then may be operably passed through a fault protection 124, and on to a DC bus 125 desirably carrying one hundred-twenty volts (120V) or more or less volts. Alternatively, however, the DC produced by the rectifier/converter 122 may pass through an inverter/micro-inverter 126 to be converted to AC, which then may be operably passed through a fault protection 124 and on to an AC bus 127 desirably carrying one hundred-twenty volts (120V) or more or less volts. A single line/conductor is illustrated in FIG. 13, and the use of either a DC bus 125 or an AC bus 127 is designated by the numerals “125/127”, and refers to either DC or AC, as described herein and illustrated in FIG. 13. The AC carried by the AC bus 127 may be carried to a power storage unit 128 and/or may be carried to an external AC transformer 129 which may collect the AC from a plurality of generators 24 and/or modules 10 to transform the collective AC to much higher voltage for long distance transfer of electricity such as but not limited to ten thousand AC volts (10 kV) via a high voltage conductor 131. Similarly, the DC carried by the DC bus 125 may also be carried to the power storage unit 128 and/or an external DC booster 130 to transform the DC to much higher voltage for long distance transfer of electricity such as but not limited to ten thousand DC volts (10 kV) via a high voltage conductor 131. In one embodiment, the high voltage DC booster 130 or high voltage AC transformer 129 may be contained inside a waterproof modified module such as by way of non-limiting example, module 200 (modified module 200 is described below and illustrated herein) or a variation of module 200, or a secondary housing 18 of a module 200, or the like. Additionally, since the high voltage DC booster 130 or high voltage AC transformer 129 boosts the voltage produced by a plurality of generators 24, these modified modules 200 or secondary housings 18 only need to be installed in only one out of approximately 150 to 200 modules. Moreover, the high voltage DC booster 130 may incorporate additional energy storage units 128 such as, by way of non-limiting example, one or more capacitors (not shown) to collect energy produced by a plurality of generators 24 in order to boost the DC to high voltage For purposes of brevity only herein, and as will be understood by those having ordinary skill in the art, very high voltage such as but not limited to AC 10 kV or the DC 10 kV may be carried on at least one high voltage bus/conductor (collectively shown as bus “131”).

In the case of very high voltage DC power that is ultimately sent to a power grid, for example ten thousand DC volts (10 kV) power, the power will desirably first be inverted from DC to AC via an inverter (not shown). For further purposes of brevity only herein, DC power carried only on a DC bus 125, or both DC bus 125 and 131 may be converted to AC power via one or more inverters (not shown) to power AC electric motors operably linked to DC bus 125, 131, or both. Alternatively, the DC may power DC motors operably linked to DC bus 125, 131, or both without being inverted to AC. Whereas AC power carried only on AC bus 127 or both AC bus 127 and 131 may be used to power AC motors operatively linked to AC bus 127, 131, or both and the power may be first stepped down or up via one or more transformer, or if that AC power is used to energize a DC motor it will rectified to DC power via a rectifier/converter and the voltage may also be stepped up or stepped down with a transformer or other item(s). The power or current transferred throughout the power generating apparatus of this invention is moved or transferred along insulated conductors and the conductors may also be contained inside conduit.

In either instance, current from the DC bus 125 and/or AC bus 127 may be used within each module 10, as well as carried outside of each module 10. The electrical current, from the secondary housing 18 may desirably be carried by/through at least one connector 132 which is used to connect to one or more other lines/connectors/conductors (not shown) to carry the electrical current to and from the module 10. The electrical current (via DC bus 125 and/or AC bus 127), as noted, may be transferred and held in one or more power storage units 128, which may include, for example, but not by way of limitation, capacitors, batteries, flywheels, and/or any other equivalent apparatus commercially available which functions as shown and/or described herein. In the case of AC power sent to power storage units such as capacitors or batteries, that power will first be converted to DC. In any place where two electrical conductors must be joined together a connector may be used and by way of non-limiting example the connector may include high vibration resistance connector(s), male and female spade connectors, male and female buttle connector, or any other connector(s) commercially available which operates as shown and/or described herein.

Additional connectors 134, 136 may be used to connect fluid carrying fluid lines or pipelines through the secondary housing 18 and any chambers 112, 114, 116 therein. It will be appreciated that multiple connectors may be used for fluid, electrical and other connections, so that the module 10 or 200 and its/their components are quickly connected and disconnected for repair or replacement to maintain traffic flow over the modules 10/200 and platform 30.

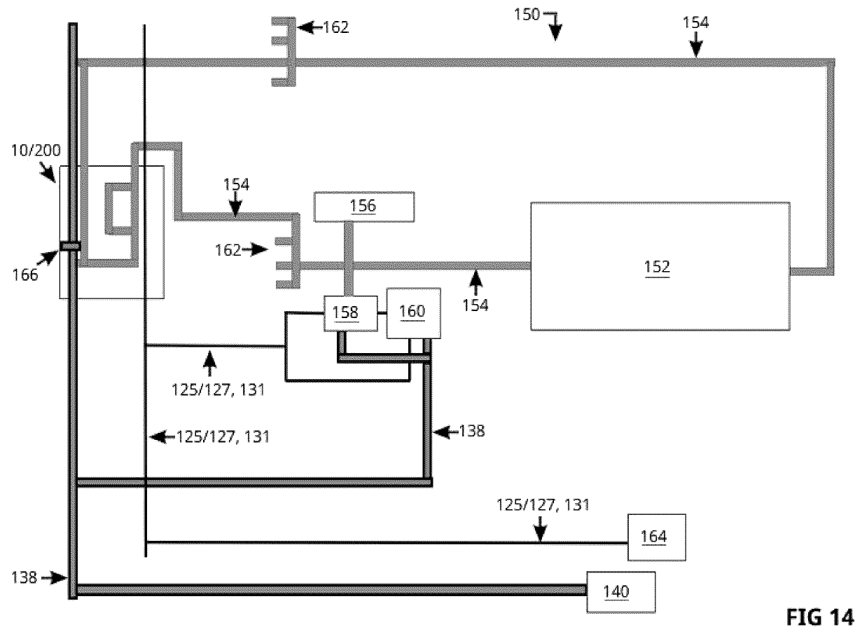

A communications/data/bus 138 may desirably be provided within the secondary housing 18, as shown in FIG. 13. The communications/data bus 138 may include, by way of non-limiting example, a conductor, a fiber optical cable, and/or any one of or a combination of a transmitter, receiver, and/or antennae. Desirably, data is communicated to and from each module 10 to a controller 140 (FIG. 14). Such a controller 140 desirably at least includes a microprocessor, and more desirably may be a computer further including memory, a variety of software, a screen, keyboard, and the like.

Data and/or signals may desirably be communicated via the communications/data bus 138 from sensors, gauges, meters, and the like, (collectively “sensors”) positioned within the secondary housing 18, as well as in other areas within and outside of the module 10 (not shown). For example, data from sensors may include temperature, pressure (psi), the presence of water, electric current voltage, and the like. Moreover, in response to data input to the controller, the controller controls elements within and outside of each module 10, such as, for example, but not by way of limitation, one or more pumps, one or more heating elements, one or more cooling elements, the movement of fluids through tubing inside of and outside of each module, control of electrical current, and the like. The controller 140 is desirably configured to evaluate the operation and performance of each module 10, and convey the information to an operator, who may set or adjust parameters of the operation of the various areas of the platform 30. Such a controller 140 may be operably connected to one or more modules 10, and it may be wirelessly connected.

A module cooling and heating system 150, as illustrated in FIG. 14, may include, but not by way of limitation, a geothermal heating and cooling system 152. Of course, alternative heating and cooling systems may also be used. In this example, the geothermal heating and cooling system is capable of providing either cooled fluid or heated fluid through a pipeline 154 that, as shown in FIG. 14, extends through a module 10 and/or 200, and more desirably, extends through the plurality of modules 10 and/or 200 contained within an entirety of the platform 30. The pipeline 154 desirable includes at least one tank 156 and at least one pump 158 which is electrically powered via electric line AC bus or DC bus 125/127, respectively, or 131. Alternatively, as needed, a back-up power device, such as a battery 160 is also provided to power the pump 158. Fluid is desirably pumped via the at least one pump 158 through the pipeline 154 either directly from the geothermal heating and cooling system 152 and/or the tank 156 to a manifold 162. It will be understood that each manifold 162 may provide fluid to one or a plurality of modules 10 and/or 200 (module 200 described in further detail below), and fluid in the pipeline 154 may be moved away from the plurality of modules 10 and/or 200 via the manifold 162 and the pipeline 154 may return the fluid to the geothermal heating and cooling system 152 and/or the tank 156. Piping 154 within the platforms 30 or above ground or in other locations may be coated or covered with insulation 71 or insulating material 71 in areas where the heating or cooling energy contained in the fluid in the piping 154 or tank 156 needs to be maintained in the fluid 154. The fluid used to transfer heating or cooling energy in the geothermal system 150 is water or contains water and may incorporate an anti-freeze additive such as but not limited to glycol. The heating and cooling system 150 may be a closed loop system or an open loop system. Any commercially available heating and cooling system may be used, so long as the system operates as shown and/or described herein.

It will be appreciated that AC bus or DC bus 125/127 or 131 connects to each module 10 and/or 200, to each pump 158 and the back-up battery 160, to a controller 140, and to a power grid 164, and/or to any other apparatus shown and/or described herein or known in the art and commercially available.

Similarly, a communication/data bus 138 may be desirably positioned in or adjacent to the plurality of modules 10 and/or 200 and communicates with the thermostat/temperature sensor(s) 166 of each module 10 or 200. The communication/data bus 138 also communicates with the pump 158, the back-up battery or power device 160, and the electrical connections 125/127 or 131, and the like. With selective heating and cooling of the plurality of modules 10 and/or 200, when conditions such as snow, sleet, or ice occur, the selective heating of the modules 10 and/or 20 may keep the platforms 30, roadway 36 dry or at the worst only wet, when the remaining roadway 36 may be covered with the snow, sleet, or ice. Therefore, use of the electric generating apparatus 10 provides an improved and safer roadway 36 and platforms 30 for vehicles to drive on during such inclement weather and ground conditions.

Turning now to FIG. 15, the module 10 may include an additional module 200. The modules 10 may be spaced apart, and in this example, but not by way of limitation, the modules 10 may desirably be transversely oriented relative to each other and interconnected. However, module 10 may be connected to a similar but different module 200.

One or more fail-safe solutions (not shown) may be installed at one or more locations of each power generating module 10 to prevent a protrusion 12, 14 from remaining in a protruded state if an object 38 passing overhead would otherwise fail to depress or compress the protrusion 12, 14 because of a mechanical or immobilization problem with one or more items of the power generating module 10. The fail-safe is engineered or designed to break or break away when a predetermined weight or force on that item is exceeded. The fail-safe may be or may be incorporated into by way of non-limiting example, pin, linkage, clutch, break away rotatable shaft connector, and the like.

Module 200 may appear externally to be an identical mirror image of module 10. In this alternative, however, module 200 may only be provided with the pair of protrusions 12, 14, and push force to rotation force assemblies 96, connected to the rotatable shaft 20 may desirably operably be connect to a driveshaft 202. The drive shaft 202 may extend through a first external conduit 204 which extends transversely from module 200 to module 10, and it may operably connect to an interface/adapter 206 which is desirably operatively connected to the gearbox 22 or equivalent within the secondary housing 18, or alternatively, the driveshaft 202 may be operably connected to the generator(s) 24 within the secondary housing 18 of module 10. The interface/adapter 206 permits any misalignment between the driveshaft 202 and the rotatable shaft 20 to be overcome to transfer torque effectively. The interface/adapter 206 may be any one of, but not limited to, a coupler, spider coupler, universal joint, or any other mechanism commercially available and known in the art, which functions as shown and/or described herein. When module 200 is operably connected via the driveshaft 202 through the first external conduit 204 to the secondary housing 18 of module 10, the gearbox 22 or equivalent, and/or the generator(s) 24 of module 10 are shared with module 200 to produce electricity only through module 10. In this alternative, in module 200, only certain components may be contained within the secondary housing 18 of module 200, such as, for example, but not by way of limitation, at least a portion of a heating/cooling assembly 150, sensors, and the like, as well as communications and electrical connections and/or conductors, and the like. Some or all of these components may be provided via a second external conduit 208 which extends between the module 10 and the alternative module 200.

The interconnected modules, such as, for example only, modules 10 and 10, or alternatively, modules 10 and 200, are desirably spaced-apart such that transversely spaced-apart pairs of front tires 38 and spaced-apart pairs of rear tires 38 of vehicles 40 will each pass over at least one protrusion 12, 14 of each module 10/10 or 10/200 of each pair of spaced-apart modules 10/10 or 10/200.

In this manner, a plurality of modules 10/10, or, alternatively, 10/200, each form an axially aligned first subset 210 of a plurality of modules 10 and a spaced-apart and substantially parallel second subset 212 of another plurality of modules 10/10 or 10/200 positioned in one lane 32 of a roadway 36, as shown in FIGS. 16-22. In one alternative, only the first subset 210 is positioned in one lane 32 of the roadway 36, and a second subset 212 may be positioned in another lane 32 of the roadway 36. “Substantially parallel”, as used herein, means that modules 10/10 or 10/200 are positioned within plus or minus 15 percent of parallel relative to each other. It will be appreciated that this spacing is based on the curvature of the underlying roadway 36.

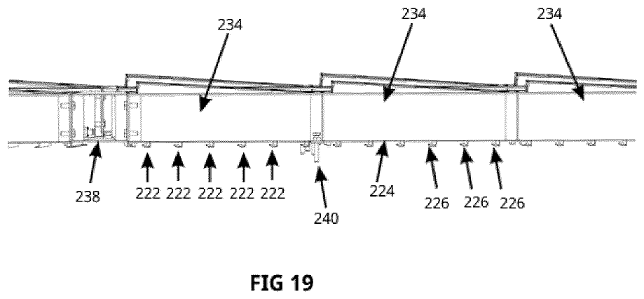

Referring to FIGS. 16-20, to position the first and second subsets 210, 212 on a lane 32 of a roadway 36, first and second spaced-apart subset housings 214, 216 are provided and positioned over the desired lane(s) 32 of the roadway 36. Each first and second subset housing 214, 216 include a floor 218 and at least a pair of spaced-apart vertically oriented sidewalls 220 positioned on opposing edges of the floor 218 and connected thereto by welding, by fasteners, or by any apparatus or means known in the art. A lower surface 224 of the floor 218, that is, the surface 224 of the floor 218 which contacts the roadway 36, may also include one or more ribs 222 (FIG. 19) which extend from the lower surface 224 of the floor 218. The one or more ribs 222 may protrude, curve, bend, and the like, especially at a free end 226 thereof, to permit the free end 226 of each rib 222 to grip a surface or a material positioned over the surface of the lane 32 of the roadway 36. At least some sidewalls 220 may include openings 228, 230 formed therein that may carry the first external conduit 204 and the second external conduit 208 between modules 10/10 or 10/200. It will be appreciated that either first or second conduits 204, 208 may carry a plurality of other items, such as electrical and/or fluid connections, and the like. Further, an additional conduit (not shown) may be added to connect both modules together to remove unwanted water or debris from the modules 10/10 or 10/200 (not shown). All conduits may be made from at least one of a plastic, a metal, rubber, and the like. Any conduit known in the art and commercially available that operates as shown and/or described herein may be used. In a further addition, pipe(s), tubes(s), and the like may extend separately from each module to permit water, dirt, and the like, to drain from each module 10/10 or 10/200 (not shown).

The first and second subset housings 214, 216 are formed in a plurality of sections 232, as shown in FIGS. 16-20, and each section 232 desirably may include a plurality of compartments 234. Each compartment 234 includes an inner periphery 236 that is adapted to receive at least one module 10/200 of the plurality of modules 10/200. A module 10 or 200 is desirably inserted into the inner periphery 236 of each compartment 234 such that only the top surface 16 of each module 10/200 remains uncovered. Each module 10/200 may be connected to each compartment 234 by one or more fasteners, or by any apparatus or material known in the art. Each module 10/200 may be desirably removably sealed in each compartment 234 via any apparatus or material shown and/or described herein or known in the art and commercially available. Each section 232 of the first and second subset housings 214, 216 may include one or more spacers 238.

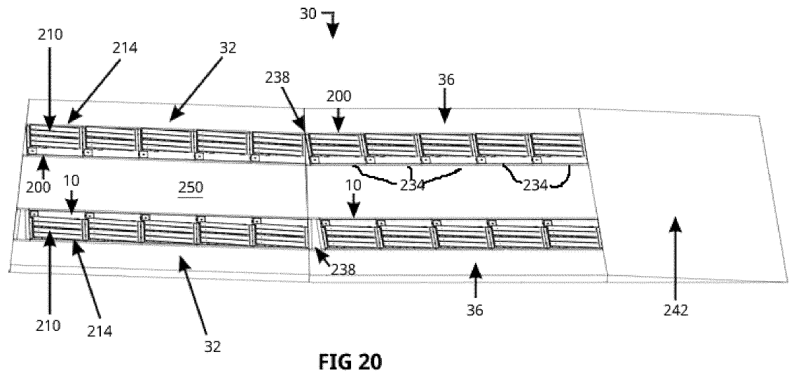

The spacers 238 may be of varying sizes and configurations, as illustrated in FIGS. 16-20, to permit the first and second subset housings 214, 216 to conform to each lane 32 of the roadway 36 when the lane 32 turns left or right (as illustrated), or when the lane 32 is positioned downward at the bottom of a hill, or positioned upward, such as at the summit of a hill (not shown), and the like. It will be appreciated that the spacers 238 will also be formed to conform to the shape and size of the first and second subset housings 214, 216, and modules 10/200 as well. The first and second subset housings 214, 216 carry the first and second subsets 204, 208 respectively, of the plurality of modules 10/200 in one or more lanes 32 of the roadway 36, and the first and second subset housings 214, 216 along with the modules 10/200 cooperate to form each raised platform 30 which may be positioned over one or more lanes 32 of the roadway 36. Each first and second subset 210, 212 of modules 10/200 held in respective first and second subset housings 214, 216 to provide the platform 30, and all of the foregoing are axially aligned with the roadway 36, as illustrated in FIGS. 20-21.

Turning back to positioning first and second subset housings 214, 216 on a lane 32 of a roadway 36, a surface of the lane 32 of the roadway 36 may require preparation before carrying the platform 30. Therefore, the roadway 36 may desirably be smoothed or filled by a filler, such as, for example, but not by way of limitation, asphalt, concrete, or any material(s) commercially available which accomplishes the task. When the first and second subset housings 214, 216 are positioned in each lane, the first and second subset housings 214, 216 are desirably leveled by use of levelers 240, such as, for example, bolts attached to at least each section 232, and perhaps each compartment 234, of the first and second subset housings 214, 216. However, other apparatus, such as shims, or any apparatus known in the art and commercially available which operates as shown and/or described may be used. In addition, bolts, rods, and other mechanisms known in the art and commercially available may also be used to securely affix the first and second subset housings 214, 216 to the lane(s) 32 of the roadway 36 to provide the platform 30.

The raised platform 30 desirably includes a sloped ramp 242 at the beginning of the platform 30 and at the end of the platform 30. The ramp 242 desirably may be a long ramp 242 to provide a smooth transition of the vehicle between the roadway 36 and the platform 30. It will be appreciated that an additional gradually sloped area may be formed or provided on each outer side of the roadway 36, to provide additional safety for a vehicle that needs to pull to the side of the roadway 36 and off of the platform 30.

All components of the modules 10/200, the frame 25, the secondary housing 18, the various chambers 112, 114, 116 therein, the subset housings 214, 216, and other apparatus herein, may be formed from metal, metal alloys, and ferrous-containing material(s). Examples of metals which may be used include, but are not limited to, galvanized steel, stainless steel, aluminum, titanium, and the like. The metal and/or metal alloys may desirably be protected against corrosion by either applying an anticorrosive coating, or by treating the metal and/or metal ally via a cathodic protection method, which is known in the art and commercially available.

At least the first and second subset housings 214, 216, may include one or more expansion joints to accommodate expansion due to heat and contraction due to cold. Expansion joints are known and commercially available, and any expansion joint may be used so long as it operates as shown and/or described herein.

As illustrated in FIGS. 21-23, when the tire(s) 38 of a vehicle 40 move over the lane 32 of a roadway 36, the tires 38 on the left side 244 of the vehicle 40 will contact one or both of the pair of protrusions 12, 14 of each module 10 of the plurality of modules of the first subset 210, while the tires 38 on the right side 246 of the vehicle 40 will contact one or both of pair of protrusions 12, 14 of each module of the plurality of modules 10 or 200 of the second subset 212. It will be understood that the positioning of the modules in the subsets may be reversed, such that modules 10 may be in the second subset, and modules 10 or 200 may be in the first subset 210. Due to the spacing of tires 38 of a vehicle 40, which activate the protrusions 12, 14 and therefore the push force to rotation force assembly 96, no modules 10 and/or 200 are included in a center portion 248 of the lane 32, namely, the space between the area traveled by the tires 38 of the vehicle 40. This area is deemed an “inactive area” 250, and as used herein, the term means that it is an area that is not actively harnessing the weight/force of moving vehicles, it and contains no modules actively harnessing the weight/force of moving vehicles therein. Therefore, it is anticipated, but not by way of limitation, that the first and second external conduits 204, 208, and other conduits (not shown) and the items they contain, such as, for example only, pipelines 154, are the only components which may traverse the inactive area 250 of the center portion 248. The center portion 248 requires a material or a cover to permit the center portion to have a substantially level surface which is at the same level as the protrusions 12, 14, when they are in the secondary (flat) position 68.

Material(s) which may be used to fill the center portion 248 include, for example, but not by way of limitation, asphalt, concrete, chip and seal material, and any other materials commercially available which permit the center portion 248, the inactive area 250, and the platform 30 to operate as shown and/or described herein. Alternatively, the center portion 248 may include a cover, such as for example only, a metal plate (not shown) positioned over the center portion 248.

Turning back to module 10 or 200, vibration may occur as the tires of a vehicle pass over the module 10/200. Therefore, each module may include one or more particle damping containers, filled with an appropriate particle damping material. For example, but not by way of limitation, each module may include an aluminum container filled about sixty (60) percent with 0.8 millimeter to 1.2 millimeter steel balls. It will be understood that various materials of various sizes may be used in various types of containers for vibration control within the modules 10/200 and/or the first and second subset housings 214, 216 (not shown).

The platform 30 may include reflector strips 252 to assist in delineating the lanes 32 of the roadway 36. Raised or indented strips 254 may also be used to provide a vibrational and noise signal to a driver of a vehicle 40 who may inadvertently or purposefully move a vehicle 40 partially or more onto a shoulder of the platform 30 or roadway 36.

The platform may be designed so that the plurality of modules 10/200 on the platform 30 are activated only when a force equal to or less than a specific pre-determined psi (pound per square inch) presses against one or more protrusions 12, 14 of each module 10/200 to activate the module 10/200. Therefore, when a standard force of thirty to forty (30-40) pounds per square inch (PSI) of a tire of a standard vehicle moves over one or more protrusions 12, 14 of each module 10 or 200, the psi for each protrusion 12, 14 may be set, for example, but not by way of limitation, at a pre-determined psi of twenty-five (25) psi. Alternatively, however, the standard force of a commercial vehicle PSI of the tires of the commercial vehicle will also press against one or more protrusions of each module 10/200 and such force will be well tolerated by the components of the modules 10/200 as well as the platform 30 and will also activate the modules 10/200. It will be appreciated that each module 10 or 200 is quickly and releasably removable from the platform 30 to be replaced for repair of the initial module 10 or 200 or new replacement thereof. This modularization permits easy and rapid repair of the platform 30 with minimal downtime, so that the passage of vehicles 40 over the platform 30 is minimally impeded. The modules 10 and 200 are formed such that each module 10/200 is easily removed without disruption to surrounding modules 10/200 and other apparatus and assemblies held within the platform 30.

The energy or current created by the raised platform 30 may be used to power components, such as, for example, but not by way of limitation, one or more pumps, and other apparatus requiring energy which are activated and being used within the platform 30. The electrical energy generated by the raised platform 30 may be used for a variety of purposes, and one such purpose, for example, but not by way of limitation, may be for a charging station somewhat near the raised platform for charging electric vehicles.

In another non-limiting example, some areas of the power generating network of the present invention may incorporate equipment that supplies power to charge the batteries of, or supply power to the motors of, electric powered vehicles that are moving overhead. In this example, electric current is transmitted wireless to the electrically powered vehicle in at least an area of the roadway through one or more of the following items (not shown): inductive conductor coils, oscillator electrical circuits, power rectifier, and the like. In this example the power source(s) for the electric current that will be supplied to energize the electric vehicles is any one or more of the power sources shown and/or described herein, any power source commercially available, and/or any power source known in the art that would function as shown and/or described herein.

One or more surge protector or circuit breaker (not shown) may be incorporated in one or more locations of the module 10, the platform 30, or any component(s) shown and/or described herein to protect from voltage spikes resulting from, for example, but not by way of limitation, lightning strikes, power equipment malfunctions, operator error, and so forth.

Turning to FIGS. 24 and 25, a radial generator 300 and an axial flux generator 310 are illustrated. The radial generator 300 includes an end cover 302, a rotor with a plurality of magnets 304, a stator with insulated windings 306, and a housing 308. The axial flux generator 310 includes a cover 312, a first rotor 314 including a first plurality of magnets 316, a stator 318 with insulated windings 320, a second rotor 322 having a second plurality of magnets 324, and a housing or cover 326. Other generators may be utilized, so long as such generators are commercially available and operate as shown and/or described herein.

The foregoing is considered as illustrative only of the principles of the disclosure. Further, since numerous modifications and changes will readily occur to those of ordinary skill in the art, it is not desired to limit the disclosure to the exact construction and operation shown and described, and accordingly, all suitable modifications and equivalents may be resorted to, and fall within the scope of this disclosure.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An electrical generating apparatus, comprising:
a raised platform positioned on a surface that at least one vehicle traverses, the platform including a housing configured to conform to a roadway, the housing configured to receive a plurality of modules, each module of the plurality of modules including 1) at least one protrusion, 2) at least one rotatable shaft, and 3) at least one generator, wherein the at least one protrusion, the at least one rotatable shaft, and the at least one generator are operably connected within each module;
at least a portion of the at least one protrusion of each module of the plurality of modules is configured to extend above an upper surface of each module in an initial position, and the at least a portion of the at least one protrusion is configured to be in a flat or planar position relative to the upper surface of each module when in a secondary position, and at least one reset member is positioned within each module and configured to permit movement of the at least one protrusion between the initial position and the secondary position when a push force is applied to create the movement;
wherein when the at least one protrusion of each module of the plurality of modules is pushed to a secondary position by a tire of the vehicle moving over the at least one protrusion, the movement of the at least one protrusion creates a rotation force which causes rotation of the at least one rotatable shaft, which causes rotation of the at least one generator such that the at least one protrusion translates a push force to a rotation force from the at least one rotatable shaft to the at least one generator to create electrical generation therefrom;
a first subset of the plurality of modules axially aligned and positioned in a first portion of the housing of the raised platform;
a second subset of the plurality of modules axially aligned and positioned in a second portion of the housing of the raised platform;
wherein the first subset of the plurality of modules and the second subset of the plurality of modules are spaced apart from each other such that the platform includes an inactive area without electrical generation therefrom, the inactive area formed without any modules or electrical generation, and the inactive area positioned between the first subset and the second subset, such that the first subset, the inactive area, and the second subset are positioned in an axial alignment relative to each other and relative to an axial alignment of the platform which is positioned on the surface comprising a lane of the roadway,
wherein the at least one vehicle moves over and contacts the at least one protrusion of one module of the plurality of modules of the first subset or the second subset, thereby causing generation of electricity.

2. The apparatus of claim 1, wherein each module of the plurality of modules is configured to be easily and quickly disconnected from the plurality of modules and removed from the housing, to permit each module to be rapidly removed and replaced by another module of the plurality of modules.

3. The apparatus of claim 1, including a heating and cooling system, which permits a heated fluid or a coolant fluid to be circulated via fluid lines in each module, to provide heating or cooling to each module of the plurality of modules.

4. The apparatus of claim 3, wherein the heating and cooling system circulates a heated fluid to raise a temperature of each module above freezing, so when a frozen precipitation is present, the plurality of modules on the roadway will remain unfrozen which reduces or eliminates slipping of vehicles traversing over such modules in platform.

5. The apparatus of claim 4, wherein the heating and cooling system comprises a geothermal heating and cooling system.

6. The apparatus of claim 4, wherein a controller is used to control the heating and cooling system.

7. The apparatus of claim 1, wherein each module of the plurality of modules includes a primary housing and a secondary housing.

8. The apparatus of claim 7, wherein the primary housing includes a frame including a plurality of walls, wherein more than one wall of the plurality of walls includes one or more openings therein.

9. The apparatus of claim 8, wherein one or more plates are positioned on an upper edge of the plurality of walls, wherein the one or more plates provide support for the at least one protrusion, and wherein the one or more plates provide support for the at least one protrusion.

10. The apparatus of claim 1, wherein at least a portion of the at least one protrusion is connected by a linkage to at least one clutch/bearing positioned on the rotatable shaft.

11. The apparatus of claim 10, wherein the apparatus includes a gearbox, and the rotatable shaft is connected to the gearbox, the gearbox and the at least one generator are positioned in the secondary housing, and wherein a clutch/bearing is positioned between the gearbox and the at least one generator.

12. The apparatus of claim 1, wherein each module of the second subset of the plurality of modules includes one or more modules configured in a mirror image relative to the first subset of the plurality of modules.

13. The apparatus of claim 1, wherein each module of the second subset of the plurality of modules includes the at least one protrusion operably connected to the rotatable shaft, and the rotatable shaft is operably connected to a driveshaft that extends transversely between each module of the plurality of modules of the second subset to each module of the plurality of modules of the first subset, respectively, and the driveshaft operably connects to each module of the plurality of modules of the first subset via an interface/adapter operatively connected to at least one of a) a gearbox and b) the at least one generator within each module of the of the plurality of modules of the first subset.

14. The apparatus of claim 13, wherein each driveshaft is positioned in the inactive area of the platform positioned between the first subset and the second subset.

15. The apparatus of claim 1, further comprising at least one power storage unit which receives electrical generation from: a) the at least one generator of each module of the plurality of modules of the first subset and b) the at least one generator of each module of the plurality of modules of the second subset.

16. The apparatus of claim 1, wherein the housing further comprises sections, and the sections further comprise compartments for holding each module of the plurality of modules, and the housing further comprises spacers formed to be positioned between at least one of a compartment and a section, the spacers configured to permit the housing to follow the turns and contours of the roadway.

17. The apparatus of claim 1, wherein the housing is configured to be affixed to the roadway so that the ribs of the housing embed into an affixing material.

18. An electrical generating apparatus, comprising:
a raised platform positioned on a surface that at least one vehicle traverses, the platform including a housing configured to conform to a roadway, the housing configured to receive a plurality of modules, each module of the plurality of modules including 1) at least one protrusion, 2) at least one rotatable shaft, and 3) at least one generator, wherein the at least one protrusion, the at least one rotatable shaft, and the at least one generator are operably connected within each module;
at least a portion of the at least one protrusion of each module of the plurality of modules is configured to extend above an upper surface of each module in an initial position, and the at least a portion of the at least one protrusion is configured to be in a flat or planar position relative to the upper surface of each module when in a secondary position, and at least one reset member is positioned within each module and configured to permit movement of the at least one protrusion between the initial position and the secondary position when a push force is applied to create the movement;
wherein when the at least one protrusion of each module of the plurality of modules is pushed to a secondary position by a tire of the vehicle moving over the at least one protrusion, the movement of the at least one protrusion creates a rotation force which causes rotation of the at least one rotatable shaft, which causes rotation of the at least one generator such that the at least one protrusion translates a push force to a rotation force from the at least one rotatable shaft to the at least one generator to create electrical generation therefrom;
a first subset of the plurality of modules axially aligned and positioned in a first portion of the housing of the raised platform;
a second subset of the plurality of modules axially aligned and positioned in a second portion of the housing of the raised platform,
wherein the at least one vehicle moves over and contacts the at least one protrusion of one module of the plurality of modules of the first subset or the second subset, thereby causing generation of electricity.

19. The apparatus of claim 18, wherein each module of the plurality of modules is configured to be easily and quickly disconnected from the plurality of modules and removed from the housing, to permit each module to be rapidly removed and replaced by another module of the plurality of modules.

20. The apparatus of claim 18, including a beating and cooling system, which permits a heated fluid or a coolant fluid to be circulated via fluid lines in each module, to provide heating or cooling to each module of the plurality of modules, wherein the heating and cooling system circulates a heated fluid to raise a temperature of each module above freezing, so when a frozen precipitation is present, the plurality of modules on the will remain unfrozen which reduces or eliminates slipping of vehicles traversing over such modules in platform.
